(19) United States
(12) Patent Application Publication
(10) Pub. No.: US 2026/0312017 A1
(43) Pub. Date: Oct. 8, 2026

(54) NEGATIVE ELECTRODE FOR NON-AQUEOUS ELECTROLYTE SECONDARY BATTERY

(71) Applicant: TOYOTA JIDOSHA KABUSHIKI KAISHA, Toyota-shi (JP)

(72) Inventor: Daiki MAEDA, Toyota-shi (JP)

(73) Assignee: TOYOTA JIDOSHA KABUSHIKI KAISHA, Toyota-shi (JP)

(21) Appl. No.: 19/557,640

(22) Filed: Mar. 5, 2026

(30) Foreign Application Priority Data
Apr. 3, 2025 (JP) 2025-062020

(51) Int. Cl. H01M 4/36; H01M 4/133; H01M 4/134; H01M 4/38; H01M 4/583; H01M 4/02

(52) U.S. Cl. CPC H01M 4/366; H01M 4/133; H01M 4/134; H01M 4/386; H01M 4/583; H01M 2004/027

(57) ABSTRACT

A negative electrode for a non-aqueous electrolyte secondary battery includes a collector, a first active material layer, and a second active material layer in this order. The first active material layer contains first natural graphite. The second active material layer contains second natural graphite and artificial graphite. An aspect ratio of the second natural graphite is larger than an aspect ratio of the artificial graphite. An alignment angle of the first natural graphite is larger than an alignment angle of the second natural graphite. The alignment angle indicates an acute angle between a major axis diameter of a particle and a surface of the collector.

### CROSS-REFERENCE TO RELATED APPLICATION

This application claims priority to Japanese Patent Application No. 2025-062020 filed on Apr. 3, 2025. The disclosure of the above-identified application, including the specification, drawings, and claims, is incorporated by reference herein in its entirety.

### BACKGROUND

### 1. Technical Field

The present disclosure relates to a negative electrode for a non-aqueous electrolyte secondary battery.

### 2. Description of Related Art

US 2021/0391570 A discloses a negative electrode having a two-layer structure including artificial graphite and natural graphite.

### SUMMARY

Hereinafter, the “negative electrode for a non-aqueous electrolyte secondary battery” may be abbreviated as “negative electrode”. A negative electrode having a two-layer structure is proposed. In the two-layer structure, various performances are expected to be improved by having different compositions between the layers. For example, US 2021/0391570 A describes that the contact force between the active material layer and the collector is improved by unevenly distributing the natural graphite in the lower layer and unevenly distributing the artificial graphite in the upper layer. However, there is room for improvement in an adhesiveness between the separator and the active material layer.

An object of the present disclosure is to improve the adhesiveness between the separator and the active material layer.

Hereinafter, technical configurations and effects of the present disclosure will be described. However, an action mechanism includes an estimation. The action mechanism does not limit the technical scope of the present disclosure.

1. A negative electrode for a non-aqueous electrolyte secondary battery according to one aspect of the present disclosure includes a collector, a first active material layer, and a second active material layer in this order.

The first active material layer contains first natural graphite. The second active material layer contains second natural graphite and artificial graphite.

An aspect ratio of the second natural graphite is larger than an aspect ratio of the artificial graphite.

An alignment angle of the first natural graphite is larger than an alignment angle of the second natural graphite.

The alignment angle indicates an acute angle between a major axis diameter of a particle and a surface of the collector.

In a case where the adhesiveness between the separator and the active material layer is low, since the reaction is non-uniform, for example, the durability, the fast charging performance, or the like may be deteriorated.

FIG. 1 is a sectional conceptual diagram showing a first laminated structure in the present embodiment. In the drawings of the present disclosure, “NG” indicates natural graphite. “AG” indicates artificial graphite. The negative electrode 20 includes a collector 21, a first active material layer 22a (lower layer), and a second active material layer 22b (upper layer) in this order. The first laminated structure corresponds to the two-layer structure of US 2021/0391570 A. The natural graphite “NG” is unevenly distributed in the lower layer. The artificial graphite “AG” is unevenly distributed in the upper layer. In general, the negative electrode 20 is subjected to roll pressing in a manufacturing process. The graphite has a lubricating action. By the lubricating action of the artificial graphite of the upper layer, the upper layer can be smoothed during the roll pressing. The adhesiveness between the upper layer (negative electrode 20) and the separator is considered to be reduced by the smoothing of the upper layer.

FIG. 2 is a sectional conceptual diagram showing a second laminated structure in the present embodiment. In the second laminated structure, the natural graphite is unevenly distributed in the upper layer. The artificial graphite is unevenly distributed in the lower layer. In the second laminated structure, by the lubricating action of the natural graphite of the upper layer, the upper layer can be smoothed during the roll pressing.

FIG. 3 is a sectional conceptual diagram showing a third laminated structure in the present embodiment. In the third laminated structure, an adhesive layer 22d is provided on the outermost surface of the negative electrode 20. For example, the adhesive layer 22d can be formed by applying a binder coating material. The adhesiveness between the separator and the negative electrode 20 is expected to be improved by the adhesive layer 22d. However, the adhesive layer 22d (polymer binder) may be a resistive component of Li ion conduction. By forming the adhesive layer 22d, for example, the fast charging performance or the like may be significantly deteriorated.

FIG. 4 is a sectional conceptual diagram showing a fourth laminated structure in the present embodiment. In the drawings of the present disclosure, a circular element indicates an unaligned active material. An elliptical element indicates an active material aligned in the thickness direction. The alignment angle is an indicator of the alignment properties. As the alignment angle is closer to 90°, the particles are considered to be more strongly aligned in the thickness direction. In the fourth laminated structure, the second active material layer 22b (upper layer) includes both the natural graphite and the artificial graphite. There is a difference in hardness and lubricating action between the natural graphite and the artificial graphite. Therefore, the upper layer is not considered to be uniformly smoothed during the roll pressing. Further, the first active material layer 22a (lower layer) contains aligned natural graphite. Since the natural graphite of the lower layer is aligned, a variation in force applied to the upper layer may occur during the roll pressing. By the synergistic effect of the actions, the upper layer is not uniformly smoothed, and appropriate unevenness can occur in the upper layer. By the appropriate unevenness, an anchoring effect occurs, and improvement in the adhesiveness between the separator and the negative electrode is expected.

Further, an Li ion invasion path can be formed by the recessed portion of the upper layer. By the aligned natural graphite of the lower layer, fine pores extending in the thickness direction can be formed. By the synergistic effect of the actions, the curvature can be reduced. By reducing the curvature, for example, the improvement in the fast charging performance is also expected.

2. The negative electrode according to the “1” may include, for example, the following configuration. The first active material layer further contains an Si-based active material.

FIG. 5 is a sectional conceptual diagram showing a fifth laminated structure in the present embodiment. In the drawings of the present disclosure, “Si” indicates the Si-based active material. By including the Si-based active material in the negative electrode 20, improvement in the energy density is expected. Note that since the Si-based active material is significantly expanded during charging, measures against the expansion are also required. By disposing the Si-based active material in the first active material layer 22a (lower layer), the reduction of the expansion is expected. The aligned first natural graphite of the lower layer is expected to well absorbs the expansion of the Si-based active material in an in-plane direction. The unaligned second natural graphite and the artificial graphite of the upper layer are expected to well absorb the expansion of the Si-based active material in the thickness direction. The “in-plane direction” indicates any direction orthogonal to the thickness direction (Z-axis direction). The X-axis direction and the Y-axis direction are examples of the in-plane direction.

3. The negative electrode according to the “1” or the “2” may include, for example, the following configuration. An average particle diameter of the second natural graphite is larger than an average particle diameter of the artificial graphite.

In the upper layer, the appropriate unevenness is expected to be provided by the natural graphite having a larger particle size than the artificial graphite.

4. The negative electrode according to any one of the “1” to the “3” may include, for example, the following configuration. The second active material layer is thinner than the first active material layer.

By making the second active material layer (upper layer) relatively thin, the reduction of the curvature is expected.

5. A negative electrode for a non-aqueous electrolyte secondary battery according to one aspect of the present disclosure includes a collector, a first active material layer, and a second active material layer in this order. The second active material layer is thinner than the first active material layer. The first active material layer contains first natural graphite and an Si-based active material. The second active material layer contains second natural graphite and artificial graphite. An average particle diameter of the second natural graphite is larger than an average particle diameter of the artificial graphite. An aspect ratio of the second natural graphite is larger than an aspect ratio of the artificial graphite. An alignment angle of the first natural graphite is larger than an alignment angle of the second natural graphite. The alignment angle indicates an acute angle between a major axis diameter of a particle and a surface of the collector.

Hereinafter, an embodiment of the present disclosure (hereinafter, may be abbreviated as “the present embodiment”) will be described. Here, the present embodiment does not limit the technical scope of the present disclosure. The present embodiment is exemplary in all aspects. The present embodiment is not restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional conceptual diagram showing a first laminated structure in the present embodiment;

FIG. 2 is a sectional conceptual diagram showing a second laminated structure in the present embodiment;

FIG. 3 is a sectional conceptual diagram showing a third laminated structure in the present embodiment;

FIG. 4 is a sectional conceptual diagram showing a fourth laminated structure in the present embodiment;

FIG. 5 is a sectional conceptual diagram showing a fifth laminated structure in the present embodiment;

FIG. 6 is a conceptual sectional view for describing an alignment angle in the present embodiment; and

FIG. 7 is a conceptual diagram showing an example of a non-aqueous electrolyte secondary battery in the present embodiment.

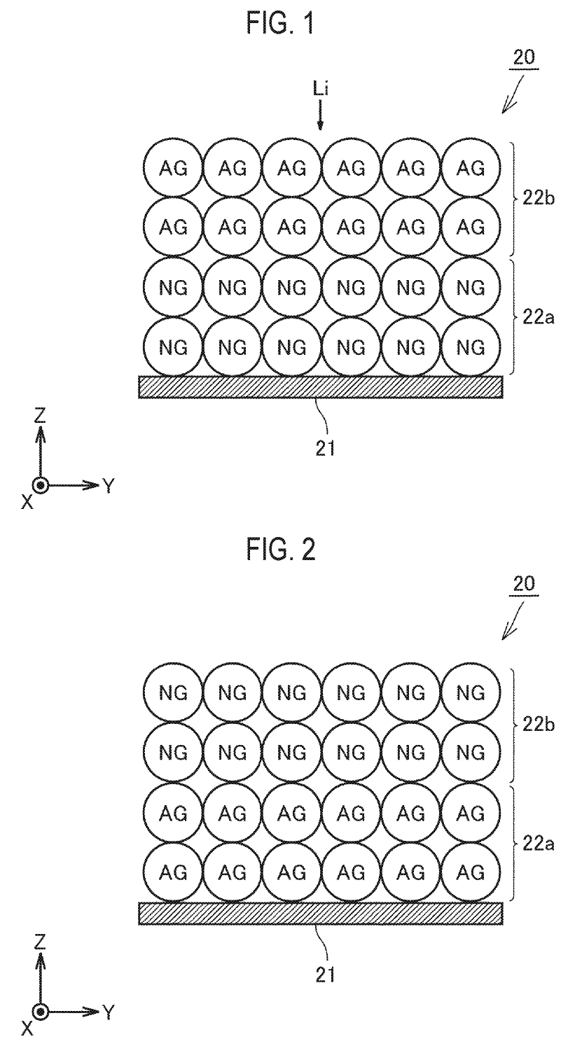

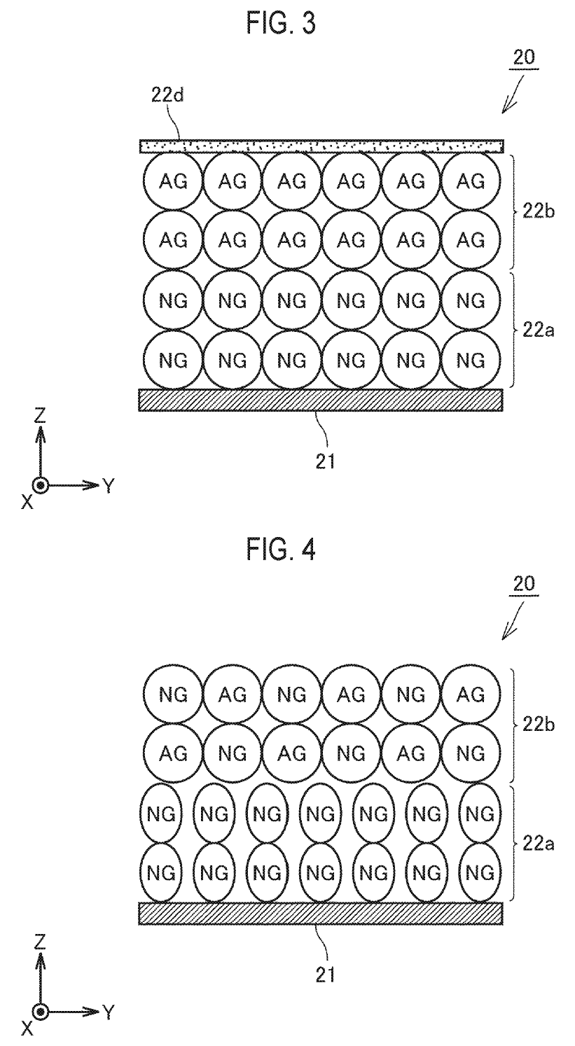

### DETAILED DESCRIPTION OF EMBODIMENTS

### Terms and Phrases

The terms “comprising”, “including”, “having”, and modifications thereof are open-ended expressions. A configuration expressed in an open-ended manner may further include or may not include an additional element in addition to the essential element. The description of “consisting of” is a closed-ended expression. However, even in a configuration expressed in a closed-ended manner, an additional element that is usually an impurity or is irrelevant to the target technology may be included. The description of “substantially consisting of” is a semi-closed-ended expression. In a configuration expressed in a semi-closed-ended manner, addition of an element that does not substantially affect the basic and novel characteristics of the target technology is allowed.

Geometric terms should not be construed in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include a tolerance, an error, or the like in design, operation, manufacturing, or the like. The dimensional relationships in each of the drawings may not match the actual dimensional relationships. For the understanding of the reader, the dimensional relationships in each of the drawings may be changed. For example, a length, a width, and a thickness may be changed. Some configurations may be omitted.

Unless otherwise specified, the singular form is not limited to a single (one) element. The singular form also includes a plurality of elements.

The “artificial graphite” indicates graphite synthesized by artificial heat treatment. The artificial graphite is also referred to as synthetic graphite (SG). The “natural graphite” indicates graphite generated in nature. The natural graphite includes flake graphite. The flake graphite may be rounded such that an end of the particle is bent. The “Si-based active material” contains Si (or an Si compound, an Si alloy, or the like) that can be alloyed with Li. The Si-based active material may contain, for example, at least one selected from the group consisting of pure Si, an Si-based alloy, SiO, and Si-C. The “Si-C” indicates a composite particle containing at least one of Si or SiO, and carbon. For example, Si may be supported on the carbon material.

The “particle diameter” is specified by a microscope method. The particle diameter indicates an arithmetic average of a long side and a short side in a minimum bounding rectangle (MBR) of a two-dimensional image of the particle. The “average particle diameter” indicates an arithmetic average of particle diameters of 100 particles randomly extracted. Various image analyses in the present embodiment may be performed by software. For example, “ImageJ” may be used.

The “aspect ratio” indicates a ratio of the long side to the short side of the MBR. An arithmetic average of aspect ratios of 100 particles randomly extracted is adopted.

FIG. 6 is a conceptual sectional view for describing an alignment angle in the present embodiment. The “alignment angle” is an acute angle “θ” between the major axis diameter “L” of the particle (for example, the natural graphite) and the surface of the collector 21 in a cross-sectional scanning electron microscope (SEM) image of the negative electrode 20. The alignment angle can take a value of 0° to 90°. The major axis diameter indicates a maximum Feret diameter of the particle. An arithmetic average of alignment angles of 100 particles randomly extracted is adopted.

The “basis weight” indicates a mass per unit area.

The “void ratio” is specified by an image analysis method. The void and the solid are discriminated by binarizing the cross-sectional SEM image of each layer. The void ratio is obtained by dividing the total area (total pixels) of the voids by the area of the entire layer.

The “active material layer” is a general term for the first active material layer and the second active material layer.

### NON-AQUEOUS ELECTROLYTE SECONDARY BATTERY

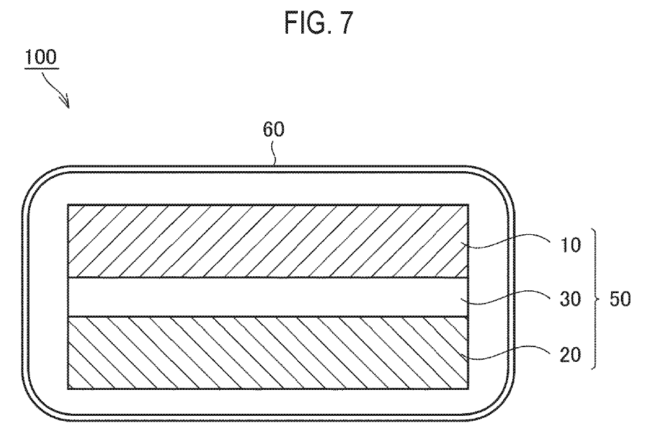

FIG. 7 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a container made of metal or a pouch made of an aluminum laminate film. The power generation element 50 may include, for example, a positive electrode 10, a negative electrode 20, a separator 30, and a non-aqueous electrolyte (not shown). The power generation element 50 may be, for example, a wound type or a laminated type. The power generation element 50 may have a monopolar structure or a bipolar structure. The separator 30 can electrically separate the positive electrode 10 from the negative electrode 20. The separator 30 may include, for example, a porous film made of a resin. The non-aqueous electrolyte is an Li ion conductor. The non-aqueous electrolyte may include, for example, an Li salt and an organic solvent. The non-aqueous electrolyte may be, for example, impregnated in the separator 30. The non-aqueous electrolyte may include, for example, a polymer electrolyte, a gel electrolyte, and a solid electrolyte. The solid electrolyte may include, for example, a sulfide solid electrolyte, an oxide solid electrolyte, and a halide solid electrolyte. The positive electrode 10 contains a positive electrode active material. The positive electrode active material may include, for example, a lithium transition metal composite oxide (Li[NiCoMn]O₂) or a lithium phosphate compound (Li[FeMn]PO₄). The description of [NiCoMn], [FeMn], and the like indicates that the total of the compositional ratios of the components in [] is “1”. The compositional ratio of each component is optional as long as the total is 1. For example, the compositional ratio of some components may be zero.

### NEGATIVE ELECTRODE

The negative electrode 20 may have a sheet-like shape, for example. The negative electrode 20 has a fourth laminated structure (FIG. 4). The negative electrode 20 includes the collector 21, the first active material layer 22a, and the second active material layer 22b in this order in the thickness direction. The active material layer may be disposed on a part of the surface of the collector 21 or may be disposed on the entire surface. The active material layer may be disposed on only one surface of the collector 21 or may be disposed on both surfaces of the collector 21. The collector 21 may include, for example, a metal foil (a Cu foil, a Ni foil, or the like) or a conductive resin layer. The collector 21 may have a thickness of, for example, 1 μm to 100 μm.

The negative electrode 20 may further include any element as long as the collector 21, the first active material layer 22a, and the second active material layer 22b are included in this order. For example, the negative electrode 20 may include the collector 21, the first active material layer 22a, the binder layer 22c, and the second active material layer 22b in this order. For example, a conductive layer, an adhesion layer (both not shown), or the like may be disposed between the first active material layer 22a and the collector 21. For example, the negative electrode 20 may include a third active material layer (not shown) between the first active material layer 22a and the second active material layer 22b.

Each layer included in the negative electrode 20 may be, for example, a coating layer. The coating layer indicates a layer formed by applying a coating material. Each coating material may be applied substantially simultaneously or may be applied sequentially. For example, before the coating material is dried, the negative electrode active material included in the coating layer can be aligned in the thickness direction by applying a magnetic field to the coating layer. For example, the alignment angle may be adjusted by the strength of the magnetic field, the concentration of the coating material, the pressing pressure, and the like.

Each layer may have any thickness. For example, the second active material layer 22b may be thinner than the first active material layer 22a. A ratio “T₂/T₁” of the thickness “T₂” of the second active material layer 22b to the thickness “T₁” of the first active material layer 22a may be, for example, 0.9 or less, 0.8 or less, 0.7 or less, 0.6 or less, 0.5 or less, 0.4 or less, 0.3 or less, 0.2 or less, or 0.1 or less. The ratio “T₂/T₁” of the thicknesses may be, for example, 0.1 or more, 0.2 or more, 0.3 or more, 0.4 or more, 0.5 or more, 0.6 or more, 0.7 or more, 0.8 or more, or 0.9 or more. The thickness of each of the layers may be, for example, 10 μm or more, 30 μm or more, 50 μm or more, 100 μm or more, 150 μm or more, 200 μm or more, 250 μm or more, or 300 μm or more. The thickness of each of the layers may be, for example, 1 mm or less, 500 μm or less, 400 μm or less, 300 μm or less, or 200 μm or less.

Each layer may have any basis weight. For example, a basis weight “W₁” of the first active material layer 22a and a basis weight “W₂” of the second active material layer 22b may satisfy a relationship of “W₁/W₂ = 1/9 to 9/1”, “W₁/W₂ = 2/8 to 8/2”, “W₁/W₂ = 3/7 to 7/3”, or “W₁/W₂ = 4/6 to 6/4”. The basis weight “W₁” may be, for example, 1 mg/cm² or more, 5 mg/cm² or more, 10 mg/cm² or more, or 20 mg/cm² or more. The basis weight “W₁” may be, for example, 50 mg/cm² or less, 30 mg/cm² or less, 25 mg/cm² or less, 15 mg/cm² or less, or 10 mg/cm² or less.

The void ratio of the active material layer may be substantially constant over the entire region. The void ratio of the active material layer may be locally different. For example, the void ratio “φ₁” of the first active material layer 22a may be higher than the void ratio “φ₂” of the second active material layer 22b. That is, a relationship of “φ₂ < φ₁” or “1 < φ₁/φ₂” may be satisfied. The ratio “φ₁/φ₂” may be, for example, 1.2 or more, 1.5 or more, 2 or more, or 2.5 or more. The ratio “φ₁/φ₂” may be, for example, 5 or less, 3 or less, or 2 or less. The void ratios of the layers may be each independently, for example, 1% or more, 5% or more, 10% or more, 20% or more, 30% or more, 40% or more, or 50% or more. The void ratios of the layers may be each independently, for example, 80% or less, 60% or less, 50% or less, 40% or less, 30% or less, 20% or less, 10% or less, or 5% or less.

### NEGATIVE ELECTRODE ACTIVE MATERIAL

The first active material layer 22a is a lower layer. The first active material layer 22a may be directly provided on the surface of the collector 21. The first active material layer 22a contains a negative electrode active material. The first active material layer 22a may further contain a conductive material, a binder, and the like. The first active material layer 22a may contain, for example, in terms of mass fraction, 0% to 10% of a conductive material, 0% to 10% of a binder, and a negative electrode active material as a remainder. The first active material layer 22a may contain, for example, in terms of mass fraction, 0.5% to 1.5% of a conductive material, 0.5% to 3% of a binder, and a negative electrode active material as a remainder.

In the first active material layer 22a, the negative electrode active material contains first natural graphite. In the first active material layer 22a, the negative electrode active material may further contain an Si-based active material. For example, in the first active material layer 22a, the negative electrode active material may consist of the first natural graphite and the Si-based active material. For example, in the first active material layer 22a, the negative electrode active material may further contain other active materials. The other active materials may include, for example, lithium titanate, a Sn-based alloy, SnO, pure Li, an Li-based alloy, and the like.

In the first active material layer 22a, the Si-based active material and the natural graphite may satisfy, for example, a relationship of “Si-based active material/first natural graphite = 1/99 to 50/50”, “Si-based active material/first natural graphite = 1/99 to 30/70”, “Si-based active material/first natural graphite = 1/99 to 20/80”, “Si-based active material/first natural graphite = 1/99 to 10/90”, or the like in terms of mass ratio.

The first natural graphite and the Si-based active material may each independently have any average particle diameter. The average particle diameter may be, for example, 1 μm or more, 5 μm or more, 10 μm or more, or 15 μm or more. The average particle diameter may be, for example, 30 μm or less, 20 μm or less, 15 μm or less, or 10 μm or less.

For example, the first natural graphite may be a large particle. For example, the Si-based active material may be a small particle. A ratio “d_{N1}/d_{S}” of the average particle diameter “d_{N1}” of the first natural graphite to the average particle diameter “d_{S}” of the Si-based active material may be, for example, 1 or more, 1.5 or more, 2 or more, 3 or more, 4 or more, or 5 or more. The ratio “d_{N1}/d_{S}” may be 10 or less, 8 or less, or 6 or less.

The second active material layer 22b is an upper layer. The second active material layer 22b may be directly provided on the surface of the first active material layer 22a. The second active material layer 22b can directly contact the separator in the non-aqueous electrolyte secondary battery 100. The second active material layer 22b may constitute the outermost surface of the negative electrode 20. The second active material layer 22b also contains a negative electrode active material. The second active material layer 22b may further contain a conductive material, a binder, and the like. The second active material layer 22b may contain, for example, in terms of mass fraction, 0% to 10% of a conductive material, 0% to 10% of a binder, and a negative electrode active material as a remainder. The second active material layer 22b may contain, for example, in terms of mass fraction, 0.5% to 1.5% of a conductive material, 0.5% to 3% of a binder, and a negative electrode active material as a remainder.

In the second active material layer 22b, the negative electrode active material contains second natural graphite and artificial graphite. For example, in the second active material layer 22b, the negative electrode active material may consist of the second natural graphite and the artificial graphite. For example, in the second active material layer 22b, the negative electrode active material may further contain other active materials (described above).

In the second active material layer 22b, the second natural graphite and the artificial graphite may satisfy, for example, a relationship of “second natural graphite/artificial graphite = 99/1 to 1/99”, “second natural graphite/artificial graphite = 90/10 to 10/90”, “second natural graphite/artificial graphite = 80/20 to 20/80”, “second natural graphite/artificial graphite = 70/30 to 30/70”, “second natural graphite/artificial graphite = 60/40 to 40/60”, or the like in terms of mass ratio.

The second natural graphite and the artificial graphite may each independently have any average particle diameter. The average particle diameter may be, for example, 1 μm or more, 5 μm or more, 10 μm or more, or 15 μm or more. The average particle diameter may be, for example, 30 μm or less, 20 μm or less, 15 μm or less, or 10 μm or less.

For example, the second natural graphite may be a large particle. For example, the artificial graphite may be a small particle. A ratio “d_{N2}/d_{A}” of the average particle diameter “d_{N2}” of the second natural graphite to the average particle diameter “d_{A}” of the artificial graphite may be, for example, 1 or more, 1.5 or more, 2 or more, 3 or more, 4 or more, or 5 or more. The ratio “d_{N2}/d_{A}” may be 10 or less, 8 or less, or 6 or less.

An aspect ratio “R_{N2}” of the second natural graphite is larger than an aspect ratio “R_{A}” of the artificial graphite. The ratio “R_{N2}/R_{A}” may be, for example, 1.1 or more, 1.2 or more, 1.5 or more, 2 or more, 4 or more, or 6 or more. The ratio “R_{N2}/R_{A}” may be, for example, 10 or less, 8 or less, 6 or less, 5 or less, or 4 or less. The aspect ratio “R_{N2}” of the second natural graphite may be, for example, 1.1 or more, 1.2 or more, 1.5 or more, 2 or more, 4 or more, or 6 or more. The aspect ratio “R_{N2}” of the second natural graphite may be, for example, 10 or less, 8 or less, 6 or less, 5 or less, or 4 or less. The aspect ratio “R_{A}” of the artificial graphite may be, for example, 1 or more, 1.1 or more, 1.2 or more, or 1.5 or more. The aspect ratio “R_{A}” of the artificial graphite may be, for example, 2 or less, 1.8 or less, 1.5 or less, or 1.2 or less.

In the negative electrode 20, the first natural graphite and the second natural graphite have different alignment properties. An alignment angle “θ₁” of the first natural graphite is larger than an alignment angle “θ₂” of the second natural graphite. That is, a relationship of “θ₂ < θ₁” is satisfied. The alignment angle “θ₁” may be, for example, 30° or more, 45° or more, 60° or more, or 75° or more. The alignment angle “θ₁” may be, for example, 90° or less, 75° or less, or 60° or less. The alignment angle “θ₂” may be, for example, less than 30°, 15° or less, or 5° or less. The alignment angle “θ₂” may be, for example, 0° or more.

For example, the first natural graphite may be the same material as the second natural graphite. For example, the first natural graphite and the second natural graphite may have, for example, different sizes, shapes, and the like. For example, an average particle diameter “d_{N2}” of the second natural graphite may be larger than an average particle diameter “d_{N1}” of the first natural graphite. The average particle diameter “d_{N1}” of the first natural graphite may be larger than the average particle diameter “d_{N2}” of the second natural graphite. For example, an aspect ratio “R_{N2}” of the second natural graphite may be larger than an aspect ratio “R_{N1}” of the first natural graphite. For example, the aspect ratio “R_{N1}” of the first natural graphite may be larger than the aspect ratio “R_{N2}” of the second natural graphite.

### BINDER

The binder may include, for example, styrene butadiene rubber (SBR), carboxymethyl cellulose (CMC), polyacrylic acid (PAA), or polytetrafluoroethylene (PTFE). The mass fraction of the binder may be substantially constant over the entire region of the active material layer. The mass fraction of the binder may be locally different. For example, the mass fraction of the binder may be different between the first active material layer 22a and the second active material layer 22b. For example, a mass fraction “M_{1B}” of the binder in the first active material layer 22a may be higher than a mass fraction “M_{2B}” of the binder in the second active material layer 22b. That is, a relationship of “M_{2B} < M_{1B}” or “1 < M_{1B}/M_{2B}” may be satisfied. The ratio “M_{1B}/M_{2B}” may be, for example, 1.2 or more, 1.5 or more, 2 or more, or 2.5 or more. The ratio “M_{1B}/M_{2B}” may be, for example, 3 or less or 2 or less.

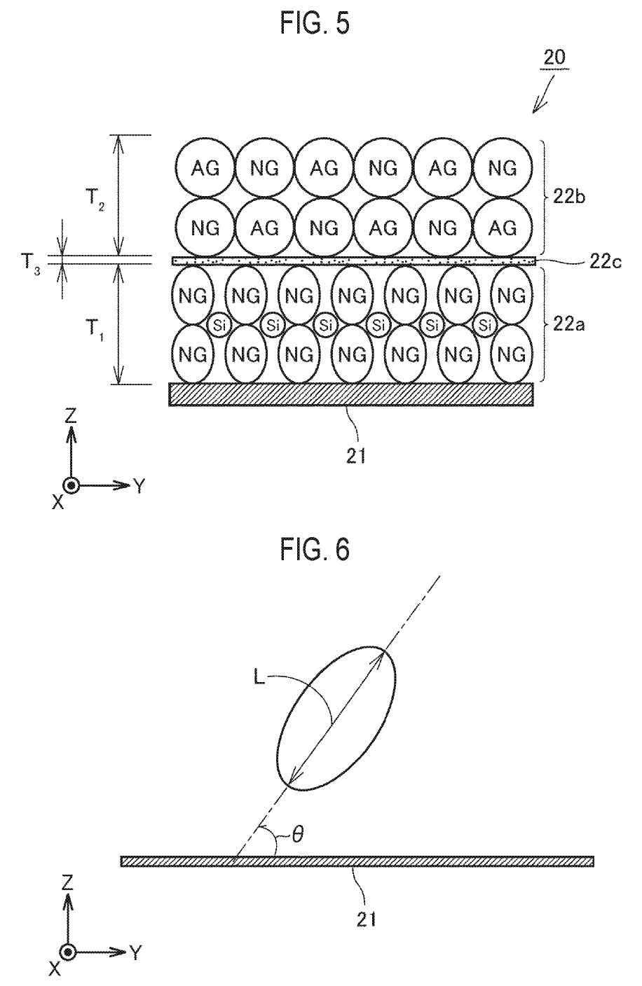

As shown in FIG. 5, for example, a binder layer 22c may be provided between the first active material layer 22a and the second active material layer 22b. A mass fraction of the binder in the binder layer 22c is higher than a mass fraction of the binder in the first active material layer 22a and the second active material layer 22b. The binder layer 22c may be a layer that substantially does not contain a negative electrode active material. The binder layer 22c may contain, for example, in terms of mass fraction, 0% to 10% of a conductive material, and a binder as a remainder. The binder layer 22c may contain, for example, in terms of mass fraction, 1% to 5% of a conductive material, and a binder as a remainder.

For example, the type of the binder may be the same between the layers. For example, the type of the binder may be different between the layers. For example, the binder in the binder layer 22c may include a resin that swells with an electrolytic solution. For example, the binder in the binder layer 22c may include a resin having ion permeability or a resin having ion conductivity. The improvement in the charge rate characteristics is expected by allowing the electrolytic solution and the Li ions to permeate the binder layer 22c. For example, the binder in the binder layer 22c may include a fibrous resin. The fibrous resin may extend to crosslink the first active material layer 22a and the second active material layer 22b. By crosslinking the first active material layer 22a and the second active material layer 22b with the fibrous resin, for example, the improvement in the peel strength is expected. The binder in the binder layer 22c may contain, for example, at least one selected from the group consisting of PAA, polyacrylic acid ester, CMC, alginic acid, polyvinylidene fluoride (PVDF), poly(vinylidene fluoride-co-hexafluoropropylene) (PVDF-HFP), and PTFE. For example, PAA, PVDF, PVDF-HFP, and the like may have swellability, ion permeability, or ion conductivity. For example, PTFE may be fibrous.

A thickness “T₃” of the binder layer 22c may be, for example, smaller than the thickness “T₁” of the first active material layer 22a and the thickness “T₂” of the second active material layer 22b. The thickness “T₃” of the binder layer 22c may be, for example, 10 μm or less, 5 μm or less, or 3 μm or less. The thickness “T₃” of the binder layer 22c may be, for example, 0.5 μm or more, 1 μm or more, or 3 μm or more. A basis weight “W₃” of the binder layer 22c may be, for example, smaller than the basis weight “W₁” of the first active material layer 22a and the basis weight “W₂” of the second active material layer 22b. The basis weight “W₃” of the binder layer 22c may be, for example, 5 mg/cm² or less, 3 mg/cm² or less, or 1 mg/cm² or less. The basis weight “W₃” of the binder layer 22c may be, for example, 0.1 mg/cm² or more or 0.5 mg/cm² or more.

### CONDUCTIVE MATERIAL

The conductive material may include, for example, acetylene black, carbon nanotube (CNT), vapor-grown carbon fiber (VGCF). The mass fraction of the conductive material may be substantially constant over the entire region of the active material layer. The mass fraction of the conductive material may be locally different. For example, the mass fraction of the conductive material may be different between the layers. For example, the type of the conductive material may be different between the layers. For example, the binder layer 22c may include a fibrous conductive material. The binder layer 22c may include, for example, at least one selected from the group consisting of CNT and VGCF. The fibrous conductive material may extend to crosslink the first active material layer 22a and the second active material layer 22b. By crosslinking the first active material layer 22a and the second active material layer 22b with the fibrous conductive material, for example, the improvement in the charge rate characteristics and the reduction of the interlayer peeling are expected.

What is claimed is:

1. A negative electrode for a non-aqueous electrolyte secondary battery, the negative electrode comprising:
a collector;
a first active material layer; and
a second active material layer, in an order of the collector, the first active material layer, and the second active material layer, wherein:
the first active material layer contains first natural graphite;
the second active material layer contains second natural graphite and artificial graphite;
an aspect ratio of the second natural graphite is larger than an aspect ratio of the artificial graphite;
an alignment angle of the first natural graphite is larger than an alignment angle of the second natural graphite; and
the alignment angle indicates an acute angle between a major axis diameter of a particle and a surface of the collector.

2. The negative electrode according to claim 1, wherein the first active material layer further contains an Si-based active material.

3. The negative electrode according to claim 1, wherein an average particle diameter of the second natural graphite is larger than an average particle diameter of the artificial graphite.

4. The negative electrode according to claim 1, wherein the second active material layer is thinner than the first active material layer.

5. A negative electrode for a non-aqueous electrolyte secondary battery, the negative electrode comprising:
a collector;
a first active material layer; and
a second active material layer, in an order of the collector, the first active material layer, and the second active material layer, wherein:
the second active material layer is thinner than the first active material layer;
the first active material layer contains first natural graphite and an Si-based active material;
the second active material layer contains second natural graphite and artificial graphite;
an average particle diameter of the second natural graphite is larger than an average particle diameter of the artificial graphite;
an aspect ratio of the second natural graphite is larger than an aspect ratio of the artificial graphite;
an alignment angle of the first natural graphite is larger than an alignment angle of the second natural graphite; and
the alignment angle indicates an acute angle between a major axis diameter of a particle and a surface of the collector.
